(19) United States
(12) Patent Application Publication
(10) Pub. No.: US 2008/0082323 A1
(43) Pub. Date: Apr. 3, 2008

(54) Intelligent classification system of sound signals and method thereof

(76) Inventors: Mingsian R. Bai, Hsinchu (TW); Meng-Chun Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/592,185

(22) Filed: Nov. 3, 2006

(30) Foreign Application Priority Data
Sep. 29, 2006 (TW) 95136283

(51) Int. Cl. G10L 11/06

(52) U.S. Cl. 704/214

(57) ABSTRACT

A system that integrates various intelligent classification techniques and preprocessing algorithms is provided. A feature extracting unit receives audio signals and extracts audio features for identification by using various descriptors; a preprocessing unit normalized the data for data consistency; a classification unit classifying audio signals into several categories according to the audio features.

### BACKGROUND OF THE INVENTION

1. Field of the Invention

The present invention generally relates to an audio signals processing system and method thereof, and more particularly relates to an intelligent classification system of sound signals and method thereof.

2. Description of the Prior Art

Digital music is popular in recent years due to the Internet. Many people have downloaded large number of music from the Internet and store them in the computer or the MP3 player randomly. Up to now, the categorization for music is performed manually. But when the quantity of music being accumulated gradually, the work of classifying them requires much time and labor. In particular, the work needs a skilled person to listen the music files and classify them.

Currently, in the audio feature extraction, the Linear Predictive Coding, Mel-scale Frequency Cepstral Coefficients, and so on to extract the features in the frequency domain. The frequency's feature cannot fully represent the music.

Additionally, in the data classification, Artificial Neural Networks, Nearest Neighbor Rule and Hidden Markov Models are used for image recognition and the result is very effective.

A mandarin audio dialing device with the structure of Fuzzy Neural Networks is disclosed in Taiwan's patent NO. 140662. The Fuzzy Neural Network recognizes the accent of the human speaking in the car to dial the phone number without button touching. The device uses Linear Predictive Coding to extract features from audio signals, which is unable to present all the properties of the audio signal, especially, when the audio signal mixes with background noise, like the music from car radio, the errors are produced often.

Another classification of audio signals is disclosed in U.S. Pat. No. 5,712,953. A spectrum module in a classification device receives a digitized audio signal from a source and generates a representation of the power distribution of the audio signal with respect to the frequency and the time. Its applying area is limited and not suitable for the whole music and songs.

### SUMMARY OF THE INVENTION

In view of the above problems associated with the related art, it is an object of the present invention to provide an intelligent classification system of sound signals. The invention extracts some values of songs from a spectral domain, a temporal domain and a statistical value, which present the features of songs thoroughly.

It is another object of the present invention to provide a system and method for identification of singers or instruments by using nearest neighbor rule, artificial neural network, fuzzy neural network or hidden Markov model. Such system identifies the sound of singers and instruments, then the method automatically classifies them into the singers' name or categories.

It is a further object of the present invention to provide a system and method for separating the component of mixed signals by using a independent component analysis, which can separate the singer's voice from the album CD to make Karaoke-like media, on the other view, the invention can reduce the environmental noises when recording the audio.

Accordingly, one embodiment of the present invention is to provide an intelligent classification system, which includes: a feature extraction unit receiving a plurality of audio signals, and extracting a plurality of features from the audio signal by using a plurality of descriptors; a data preprocessing unit normalizing the features and generating a plurality of classification information; a classification unit grouping the audio signals to various kind of music according to the classification information.

In addition, an intelligent classification method includes: receiving a first audio signal and extracting a first group of feature variables by using an independent component analysis unit; normalizing the first group of feature variables and generating a plurality of classification items; receiving a second audio signal and extracting a second group of feature variables; normalizing the second group of feature variables and generating a plurality of classification information; and using artificial intelligent algorithms to classify the second audio signal into the classification items, and storing the second audio signal into at least one memory.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating an intelligent system for the classification of sound signals in accordance with one embodiment of the present invention;

FIG. 2 is a schematic diagram illustrating a multiplayer feedforward network in the classification unit in accordance with one embodiment of the present invention;

FIG. 3 is a schematic diagram of another embodiment illustrating a Fuzzy Neural Network in the classification unit in accordance with the present invention;

FIG. 4 is a flow chart illustrating the method of Nearest Neighbor Rule in accordance with one embodiment of the present invention; and

FIG. 5 is a flow chart illustrating the method of Hidden Markov Model in accordance with one embodiment of the present invention.

### DESCRIPTION OF THE PREFERRED EMBODIMENT

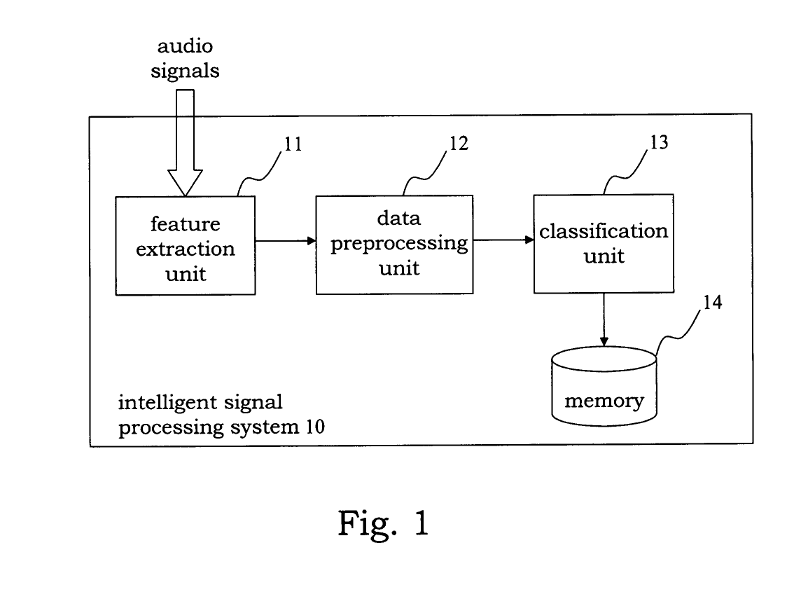

FIG. 1 is a schematic diagram illustrating an intelligent system for the classification of sound signals in accordance with one embodiment of the present invention. A feature extraction unit 11 receives audio signals and extracts a plurality of features from the audio signals by using a plurality of descriptors. The feature extraction unit 11 extracts the feature from a spectral domain, a temporal domain and a statistical value. In the spectral domain, the descriptors includes: audio spectrum centroid, audio spectrum flatness, audio spectrum envelope, audio spectrum spread, harmonic spectrum centroid, harmonic spectrum deviation, harmonic spectrum variation, harmonic spectrum spread, spectrum centroid, linear predictive coding, Mel-scale frequency Cepstal coefficients, loudness, pitch, and autocorrelation. In the temporal domain, the descriptors include: log attack time, temporal centroid and zero-crossing rate. In the statistical value, the descriptors include skewness and Kurtosis.

Furthermore, the features from the spectral domain are spectral features, the features from the temporal domain are temporal features, and the features from the statistical value are statistical features. Spectral features are descriptors computed from Short Time Fourier Transform of the signal, such as Linear Predictive Coding, Mel-scale Frequency Cepstral Coefficients, and so forth. Temporal features are descriptors computed from the waveform of the signal, such as Zero-crossing Rate, Temporal Centroid and Log Attack Time. Statistical features are descriptors computed according to the statistical method, such as Skewness and Kurtosis.

A data preprocessing unit 12 couples to the feature extraction unit 11 and normalizes the features, then generating a plurality of classification information for the intelligent signal processing system 10.

A classification unit 13 couples to the feature data preprocessing unit 12 and group the audio signals to various kind of music according the classification information by using nearest neighbor rule (NNR), artificial neural network (ANN), fuzzy neural network (FNN) or hidden Markov model (HMM).

Accordingly, the intelligent signal processing system 10 may automatically classify the received mixed signals into many groups, and store them in the memory 14. For example, the system 10 would classify the music downloaded from the Internet according to singers or instruments, wherein the music may be the mixed signal of creatures' sound signal and instruments' sound signal, the mixed signal of human's sound signal and instruments' sound signal, or the mixed signal of human's sound signal and the instrument's sound signal.

In addition, before the intelligent signal processing system 10 an independent component analysis (ICA) unit (not shown) receives an audio signal and separates it to a plurality of sound components. In the field of audio preprocessing, we may remove the voice from the songs by using independent component analysis. Besides, independent component analysis can help the system lower the noise while we record sound in a nosy environment.

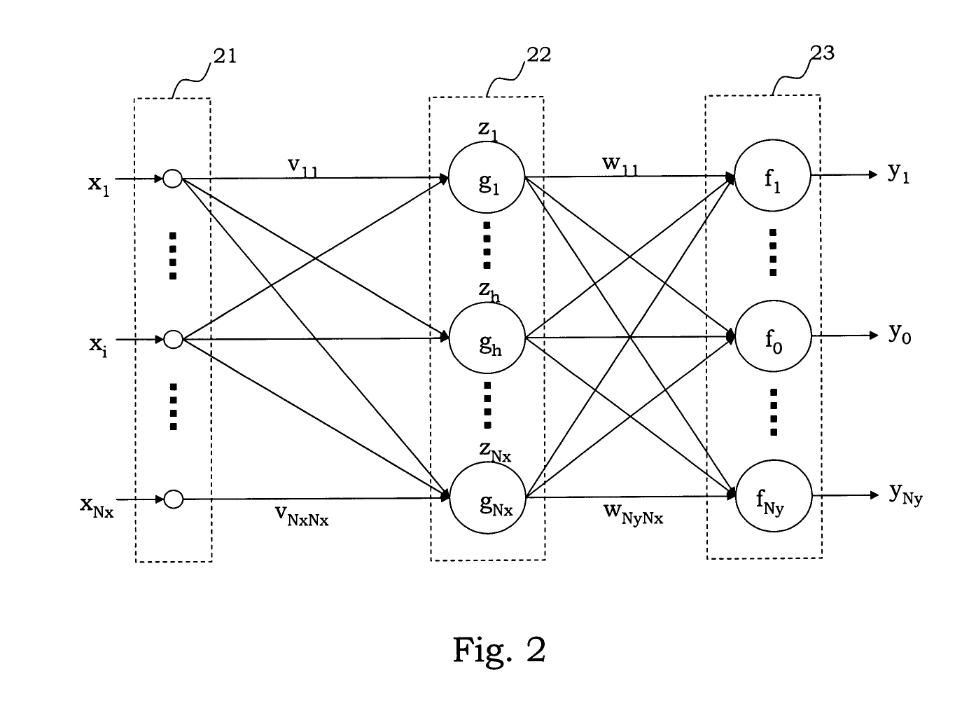

FIG. 2 is a schematic diagram illustrating a multiplayer feedforward network in the classification unit 13 in accordance with one embodiment of the present invention. The multiplayer feedforward network is used in the artificial neural network, wherein the first layer is an input layer 21, the second layer is a hidden layer 22, and the third layer is an output layer 23. The input values x₁ . . . xᵢ . . . and X_{Nx} are normalized and outputted from the data preprocessing unit 12. The input values are weighted by multiplexing the vales v₁₁ . . . and V_{NxNx} and calculated with functions of g₁ . . . gₕ . . . and g_{Nx} respectively, at the end the output values z₁ . . . zₕ . . . and z_{Nx} are obtained. Again, the output values z₁ . . . zₕ . . . and z_{Nx} are weighted by multiplexing the vales w₁₁ . . . and w_{NxNx} and calculated with functions of f₁ . . . f₀ . . . and f_{Ny} respectively to generate the output values y₁ . . . y₀ . . . and y_{Ny}. Wherein the weighted values are adjusted with the difference of output values and the targets by using the back-propagation algorithm. The errors between actual outputs and the targets are propagated back to the network, and cause the nodes of the hidden layer 22 and output layer 23 to adjust their weightings. The modification of the weightings is done according to the gradient descent method.

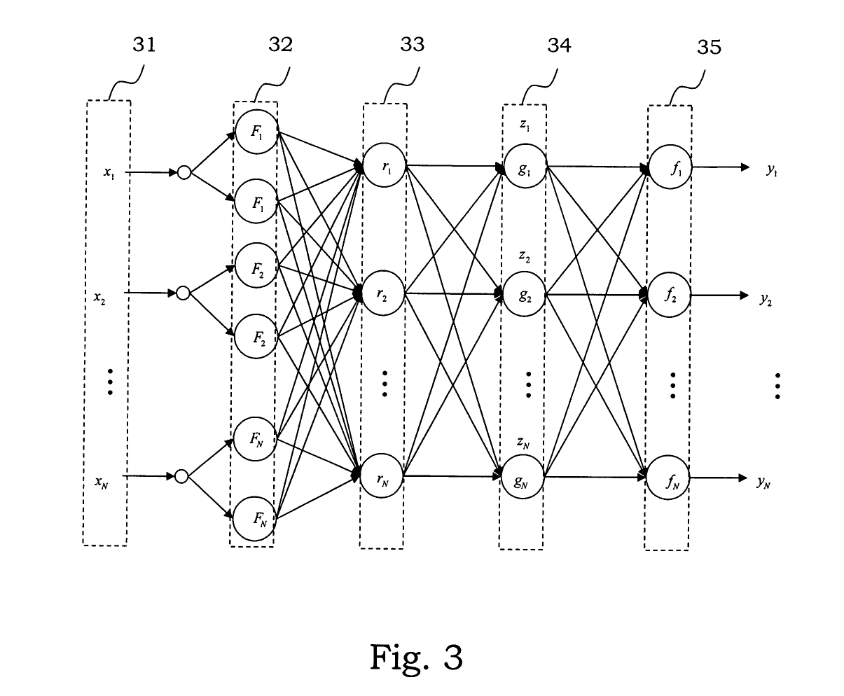

FIG. 3 is a schematic diagram of another embodiment illustrating a Fuzzy Neural Network in the classification unit in accordance with the present invention. The Fuzzy Neural Network includes an input layer 31, a membership layer 32, a rule layer 33, a hidden layer 34, and an output layer 35. The input values (x₁, x₂ . . . x_{N}) are the features of signals from data preprocessing unit 12. Next, the Gaussian function is used in the membership layer 32 for incorporating the fuzzy logics with the neural networks. And the membership layer 32 is normalized to transfer to the rule layer 33, and multiplexed with weighted values respectively to become the hidden layer 34. Lastly, the hidden layer 34 is weighted with different values to generate the output layer 35. The weighted values are adjusted with the difference of output values and the targets by using the back-propagation algorithm until the output values are proximate to the targets.

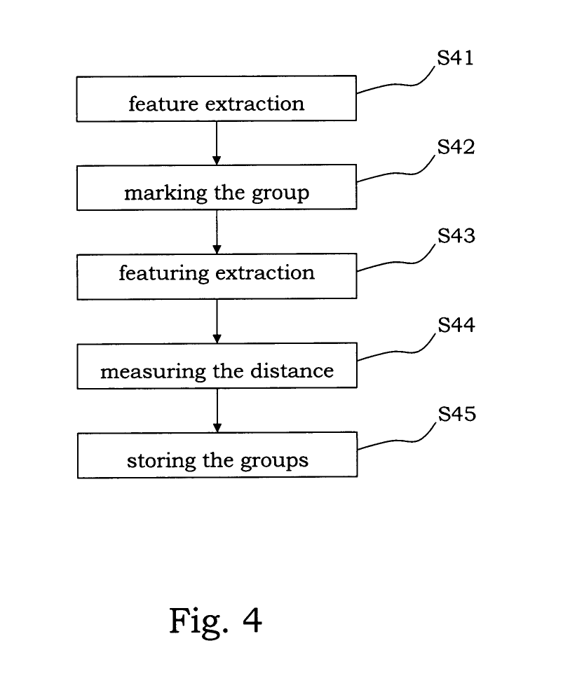

FIG. 4 is a flow chart illustrating the method of Nearest Neighbor Rule in accordance with one embodiment of the present invention. In step S41 feature extraction, an independent component analysis extracts some feature variables from a training signal. In step S42 marking group, feature variables are normalized and a plurality of classification items are generated. In step S43 feature extraction, the system receives a signal of audio and extracts some feature variables; in step S44, measuring the distance according to Euclidean distance by using the nearest neighbor rule; and in step S45, storing the groups into a memory.

The normalization process comes after feature extraction. It eliminates redundancy, organizes data efficiently, reduces the potential for anomalies during the data operations and improves the data consistency. The steps of normalization include: dividing the features into several parts according to the extraction method; finding the minimum and maximum in each data set; and rescaling each data set so that the maximum of each data is 1 and the minimum of each data is −1.

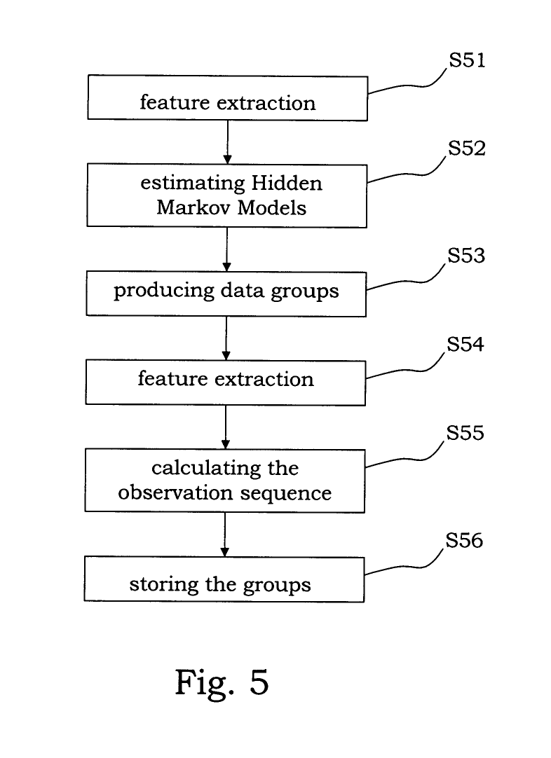

FIG. 5 is a flow chart illustrating the method of Hidden Markov Model in accordance with one embodiment of the present invention. The Hidden Markov Model is a random process, called observation sequence. In step S51 feature extraction, an independent component analysis extracts some features from a training signal. In step S52, estimating Hidden Markov Models for each feature by using Baum-Welch method, and producing data groups for those models in Step S53. In step S54, extracting a group of features from audio signals to form a new observation sequence. In step S55, calculating the observation sequence by using Viterbi algorithm. In step S56, storing the groups into a memory. For each unknown category to be recognized, the measurement of the observation sequence via a feature analysis of the signal corresponding to the category must be carried out; followed by the calculation of model likelihood for all possible models; followed by the selection of the category whose model likelihood is the highest. The probability computation is performed using the Viterbi algorithm.

Table 1 shows the experimental results of the singer identification in accordance with the present invention. The three categories are three singers (Taiwanese): Wu, Du, and Lin. Four classification techniques include NNR, ANN, FNN, and HMM. For each singer, training signals use seven songs and testing signal uses the other one that is different from those used for training (external test). The dimension of the feature space is 75. The number of the training data is 3500 and the number of testing data is 100.

TABLE 1

| Classification Method | Successful Detection Rate |
|---|---|
| Near Neighbor Rate | 64% |
| Artificial Neural Network | 90% |
| Fuzzy Neural Network | 94% |
| Hidden Markov Model | 89% |

Table 2 shows the experimental results of instrument identification in accordance with present invention. It reveals that the four classification techniques are all effective.

TABLE 2

| Classification Method | Successful Detection Rate |
|---|---|
| Near Neighbor Rate | 100% |
| Artificial Neural Network | 98% |
| Fuzzy Neural Network | 99% |
| Hidden Markov Model | 100% |

Overall, the performance of the FNN is the best, while the performance of the ANN and the HMM are satisfactory.

While several sources are mixed artificially in a PC, ICA may separate perfectly without knowing anything about the different sound sources. For example, two instruments (piano and violin) are chosen to perform the same music or different music, and then mix them in a PC. We found the ICA could successfully separate these blindly mixed signals. In another condition, several microphones record sounds in a noisy environment. With the help of ICA, the unwanted noise could be lowered but could not be lowered.

In the invention, ICA is used to separate the blind sources, to remove the voice, and to reduce the noise. We could remove the voice from songs, and reduce the noise while recording in a noisy environment by using ICA, which could be applied to a karaoke machine, a recorder, and etc.

Accordingly, the present invention receives a training audio signal, extracts a group of feature variables, normalizes feature variables and generates a plurality of classification items for training the system; next, the system receives a test audio signal, extracts feature variables, normalizes feature variables and generates a plurality of classification information; lastly, the system uses artificial intelligent calculation to classify a test audio signal into classification items, and stores the test audio signal into the memory.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An intelligent classification system of sound signals comprising:
a feature extraction unit receiving a plurality of audio signals, and extracting a plurality of features from said audio signals by using a plurality of descriptors;
a data preprocessing unit coupling to said feature extraction unit, normalizing said features and generating a plurality of classification information; and
a classification unit coupling to said data preprocessing unit and grouping said audio signals to various kind of music according to said classification information.

2. The intelligent classification system of sound signals according to claim 1, further including an independent component analysis unit receiving said audio signals and separating said audio signals to a plurality of sound sources, thereby transferred to said feature extraction unit.

3. The intelligent classification system of sound signals according to claim 2, wherein said audio signals are mixed signals of a first acoustic wave and a second acoustic wave.

4. The intelligent classification system of sound signals according to claim 3, wherein said first acoustic wave is the creatures' sound signal.

5. The intelligent classification system of sound signals according to claim 4, wherein said second acoustic wave is the instruments' sound signal.

6. The intelligent classification system of sound signals according to claim 4, wherein said second acoustic wave is the environmental noises.

7. The intelligent classification system of sound signals according to claim 1, wherein said audio signals are mixed signals of the human's sound signal and the instruments' sound signal.

8. The intelligent classification system of sound signals according to claim 7, wherein said feature extraction unit extracts said features from a spectral domain, a temporal domain and a statistical value.

9. The intelligent classification system of sound signals according to claim 8, wherein said feature extraction unit extracts said features in said spectral domain using a plurality of descriptors, wherein said descriptors comprises: audio spectrum centroid, audio spectrum flatness, audio spectrum envelope, audio spectrum spread, harmonic spectrum centroid, harmonic spectrum deviation, harmonic spectrum variation, harmonic spectrum spread, spectrum centroid, linear predictive coding, Mel-scale frequency Cepstal coefficients, loudness, pitch, and autocorrelation.

10. The intelligent classification system of sound signals according to claim 8, wherein said feature extraction unit extracts said features in said temporal domain using a plurality of descriptors, wherein said descriptors comprises: log attack time, temporal centroid and zero-crossing rate.

11. The intelligent classification system of sound signals according to claim 8, wherein said feature extraction unit extracts said features in said statistical value using a plurality of descriptors, wherein said descriptors comprises skewness and Kurtosis.

12. The intelligent classification system of sound signals according to claim 1, wherein said classification unit groups said audio signals by using nearest neighbor rule, artificial neural network, fuzzy neural network and hidden Markov model.

13. An intelligent classification method of sound signals comprising:
receiving a first audio signal and extracting a first group of feature variables by using a first independent component analysis unit;
normalizing said first group of feature variables and generating a plurality of classification items;
receiving a second audio signal and extracting a second group of feature variables;
normalizing said second group of feature variables and generating a plurality of classification information; and
using artificial intelligent algorithms to classify said second audio signal into said classification items, and storing said second audio signal into at least one memory.

14. The intelligent classification method of sound signals according to claim 13, further including receiving said second audio signal and separating said second audio signal into a plurality of sound components by using a second independent component analysis unit.

15. The intelligent classification method of sound signals according to claim 13, wherein said first audio signal is a training signal.

16. The intelligent classification method of sound signals according to claim 13, wherein said second audio signal is a mixed signal of a plurality of sound waves.

17. The intelligent classification method of sound signals according to claim 13, wherein said first group of feature variables are extracted from a spectral domain, a temporal domain and a statistical value.

18. The intelligent classification method of sound signals according to claim 13, wherein said second group of feature variables are extracted from a spectral domain, a temporal domain and a statistical value.

19. The intelligent classification method of sound signals according to claim 13, wherein said second audio signal is classified into said classification items by using nearest neighbor rule, artificial neural network, fuzzy neural network and hidden Markov model.
